(19) United States
(12) Patent Application Publication
(10) Pub. No.: US 2008/0053829 A1
(43) Pub. Date: Mar. 6, 2008

(54) Electrophoresis Apparatus and Device Therefor

(76) Inventors: Chie Hayashida, Tokyo (JP); Koji Sakairi, Tokyo (JP); Katsuyoshi Takahashi, Tokyo (JP); Yuji Maruo, Chiba (JP); Michinobu Mieda, Nara (JP); Yutaka Unuma, Chiba (JP)

Correspondence Address: NIXON & VANDERHYE, PC, 901 NORTH GLEBE ROAD, 11TH FLOOR, ARLINGTON, VA, 22203, US

(21) Appl. No.: 11/663,670

(22) PCT Filed: Sep. 5, 2006
(86) PCT No.: PCT/JP06/17490

§ 371 Date: Mar. 23, 2007

(30) Foreign Application Priority Data
Sep. 5, 2005 (JP) 2005-257124

(51) Int. Cl. B01D 57/02

(52) U.S. Cl. 204/600

(57) ABSTRACT

There is provided an electrophoresis device (100) including an insulator (10) that includes: a first-separating-medium storing section (4′) for storing therein a first separating medium (4); a first opening (7) and a second opening (8) that are in communication with the first-separating-medium storing section (4′) and for defining a direction of separation on the first separating medium (4); and a light-transmissive portion for observing inside of the first-separating-medium storing section (4′) from outside, wherein the light-transmissive portion is covered with an anti-reflective layer (3). There is also provided an electrophoresis apparatus including the electrophoresis device (100). In one embodiment of the electrophoresis device (100), the anti-reflective layer 3 is not provided, and a light absorbing layer is provided opposite the light-transmissive portion with the first-separating-medium storing section in between. In another embodiment, the anti-reflective layer (3) and the light absorbing layer (9) are provided. This realizes an electrophoresis apparatus, and a device therefor, that enables an operator to observe separated proteins at a predetermined timing during electrophoresis, without ever making contact with the electrophoresed gel, and thereby perform a sensitive quantitative analysis.

### TECHNICAL FIELD

The present invention relates to an electrophoresis apparatus and a device therefor. Specifically, the invention relates to a highly sensitive electrophoresis apparatus, and a device therefor, in which a sample is irradiated with excitation light at a desired timing during electrophoresis to detect fluorescence.

### BACKGROUND ART

In analyses using electrophoresis (for example, mass spectrometry), a cassette charged with an electrophoresis gel (separating medium) is placed in an electrophoresis chamber, and a sample that contains proteins is applied to the medium. After electrophoresis, the gel is removed from the cassette, and the stained gel is observed. A required portion of the gel is then cut out for analysis.

The electrophoresis gel used for the separation and development of the sample is thin and fragile. For the detection and/or quantification of the separated protein spots (bands) in the gel after the electrophoresis, it is required to (1) take out the cassette from the electrophoresis chamber, (2) disassembly the cassette and remove the gel, (3) transport the gel to a detection device (or place the gel on a flat immobilizing plate to transport it), and (4) dip the gel in a liquid (or immobilize on a support film) to prevent deformation. This is a complicated procedure, and it can be hazardous since the gel is toxic. Further, the procedure is time consuming because the gel is stained after the electrophoresis is finished. There have been proposed methods in which fluorescence-stained samples are used to omit the gel staining step and all other preceding steps (see Patent Publications 1 and 2, for example).

Patent Publication 1: Japanese Unexamined Patent Application Publication No. 215713/1993 (Tokukaihei 5-215713, published on Aug. 24, 1993).

Patent Publication 2: Japanese Unexamined Patent Application Publication No. 215714/1993 (Tokukaihei 5-215714, published on Aug. 24, 1993).

### DISCLOSURE OF INVENTION

However, in quantifying proteins using a fluorescence material (for example, Cy5) whose fluorescence wavelength is close to the wavelength of excitation light, detection sensitivity is affected by the reflection and/or scattering of excitation light caused by the gel and/or the cassette. This necessitates the gel to be removed from the cassette, in order to detect a trace amount of protein spot. That is, with the techniques described in Patent Publications 1 and 2, observation of separated samples still requires removal and transport of the gel from the cassette that has been detached from the electrophoresis apparatus after the electrophoresis. The operator therefore cannot avoid contacting the gel in order to observe the separated samples.

If the gel in the electrophoresis chamber could be directly observed, it would be possible to observe the sample as it is being separated by the electrophoresis, or one would be able to electrophorase the sample further. However, this has been thwarted by various types of reflected light (scattered light) generated by the electrophoresis chamber. Particularly, in observing samples stained with fluorescence material, it has not been possible to detect fluorescence which is several tens to several hundreds of magnitude smaller than the excitation light, without any loss.

The present invention was made in view of the foregoing problems, and an object of the invention is to realize an electrophoresis apparatus, and a device therefor, that enables an operator during or after electrophoresis to easily observe separated proteins without ever making contact with the electrophoresed gel, and perform a sensitive analysis without removing the gel during electrophoresis.

The inventors of the present invention found that the reflected light (scattered light) that occurs on an upper surface or lower surface of the electrophoresis chamber was particularly problematic. The invention was accomplished based on this finding.

Specifically, according to the present invention, there is provided an electrophoresis device comprising an insulator,

wherein the insulator includes:

a first-separating-medium storing section for storing therein a first separating medium;

a first opening and a second opening that are in communication with the first-separating-medium storing section and for defining a direction of separation on the first separating medium; and

a light-transmissive portion for observing inside of the first-separating-medium storing section from outside, wherein the light-transmissive portion is covered with an anti-reflective layer.

An electrophoresis device comprising an insulator,

wherein the insulator includes:

a first-separating-medium storing section storing therein a first separating medium;

a first opening and a second opening that are in communication with the first-separating-medium storing section and for defining a direction of separation on the first separating medium; and

a light-transmissive portion for observing inside of the first-separating-medium storing section from outside, wherein the light-transmissive portion is covered with an anti-reflective layer.

With the foregoing structures, an electrophoresis device according to the present invention is able to detect separated samples with good sensitivity.

An electrophoresis device comprising an insulator,

wherein the insulator includes:

a first-separating-medium storing section for storing therein a first separating medium;

a first opening and a second opening that are in communication with the first-separating-medium storing section and for defining a direction of separation on the first separating medium; and

a light-transmissive portion for observing inside of the first-separating-medium storing section from outside,

said electrophoresis device further comprising a light absorbing layer, provided opposite the light-transmissive portion with the first-separating-medium storing section in between.

An electrophoresis device comprising an insulator,

wherein the insulator includes:

a first-separating-medium storing section storing therein a first separating medium;

a first opening and a second opening that are in communication with the first-separating-medium storing section and for defining a direction of separation on the first separating medium; and

a light-transmissive portion for observing inside of the first-separating-medium storing section from outside,

said electrophoresis device further comprising a light absorbing layer, provided opposite the light-transmissive portion with the first-separating-medium storing section in between.

With the foregoing structures, an electrophoresis device according to the present invention is able to detect separated samples with good sensitivity.

In an electrophoresis device according to the present invention, it is preferable that the light absorbing layer be provided opposite the anti-reflective layer with the first-separating-medium storing section in between.

In an electrophoresis device according to the present invention, since the light absorbing layer is provided opposite the anti-reflective layer with the first-separating-medium storing section in between, there will be no reflection (scattering) of light on the rear surface of the first separating medium when an irradiating section and/or a detecting section are provided on the side of the anti-reflective layer.

In an electrophoresis device according to the present invention, it is preferable that the insulator include a first plate-insulator and a second plate-insulator, and that the first-separating-medium storing section be a depression formed in the first plate-insulator and covered with the second plate-insulator.

With the foregoing structures, an electrophoresis device according to the present invention can be realized with a simple construction.

In an electrophoresis device according to the present invention, it is preferable that the anti-reflective layer be provided on the second plate-insulator.

With the foregoing structures, an electrophoresis device according to the present invention can be realized with a simple construction, and be optionally provided with an anti-reflective layer.

In an electrophoresis device according to the present invention, it is preferable that the insulator include a first plate-insulator and a second plate-insulator, and that the first-separating-medium storing section be a depression formed in the first plate-insulator and covered with the second plate-insulator, and that the second plate-insulator be an anti-reflective layer.

With the foregoing structures, an electrophoresis device according to the present invention can be realized with a simple construction and with a reduced number of components.

In an electrophoresis device according to the present invention, it is preferable that the insulator include a first plate-insulator and a second plate-insulator, and that the first-separating-medium storing section be a depression formed in the first plate-insulator and covered with the second plate-insulator, and that the light absorbing layer be formed on the first plate-insulator.

With the foregoing structure, an electrophoresis device according to the present invention can be realized with a simple construction and be optionally provided with an anti-reflective layer.

In an electrophoresis device according to the present invention, it is preferable that the first plate-insulator be a light absorbing layer.

With the foregoing structure, an electrophoresis device according to the present invention can be realized with a simple construction and with a reduced number of components.

It is preferable that an electrophoresis device according to the present invention further include: a first buffer chamber for reserving a first buffer to be brought into contact with the first separating medium at the first opening; and a second buffer chamber for reserving a second buffer to be brought into contact with the first separating medium at the second opening.

Since an electrophoresis device according to the present invention is provided with the buffer chambers for reserving buffers necessary for the electrophoresis, there is no need to assemble the device with new buffer chambers.

In an electrophoresis device according to the present invention, it is preferable that the insulator, the first buffer chamber, and the second buffer chamber be formed in one piece.

Since an electrophoresis device according to the present invention is integrally provided with the buffer chambers for reserving buffers necessary for the electrophoresis, the device is easy to operate and/or carry around.

In an electrophoresis device according to the present invention, it is preferable that the first buffer chamber and the second buffer chamber include a first electrode and a second electrode, respectively.

In an electrophoresis device according to the present invention, it is preferable that the first opening or the second opening be shaped to fit a second separating medium retaining a sample.

In an electrophoresis device according to the present invention, the first opening or the second opening is shaped to fit the second separating medium retaining the sample. This ensures that the sample is moved to the first separating medium and separated thereon in a more sophisticated manner.

With the foregoing structure, an electrophoresis device according to the present invention can feed the first separating medium with a sample that has been separated on a different separating medium, thereby enabling the two-dimensional electrophoresis to be performed.

An electrophoresis apparatus according to the present invention includes: the electrophoresis device; irradiating means for irradiating a sample in the first separating medium; and detecting means for detecting fluorescence from the sample.

With the foregoing structure, an electrophoresis apparatus according to the present invention can sensitively detect the sample as it is being separated.

It is preferable that an electrophoresis apparatus according to the present invention further include first voltage applying means for applying voltage to the first separating medium.

In an electrophoresis apparatus according to the present invention, it is preferable that a first electrode and a second electrode to be respectively inserted in a first buffer chamber and a second buffer chamber be provided on first wiring means connected to first voltage applying means.

With the electrodes independently provided from the buffer chambers, an electrophoresis apparatus according to the present invention can easily replace or wash the electrodes.

It is preferable that an electrophoresis apparatus according to the present invention further include a separating device for separating the sample in the second separating medium.

With the foregoing structure, an electrophoresis apparatus according to the present invention realizes automated two-dimensional electrophoresis.

It is preferable that an electrophoresis apparatus according to the present invention further include second voltage applying means for applying voltage to the second separating medium in the separating device.

With the foregoing structure, an electrophoresis apparatus according to the present invention realizes automated two-dimensional electrophoresis.

In an electrophoresis apparatus according to the present invention, it is preferable that the third electrode to be inserted into the separating device be provided on second wiring means connected to the second voltage applying means.

With the foregoing structure, an electrophoresis apparatus according to the present invention realizes automated two-dimensional electrophoresis.

It is preferable that an electrophoresis apparatus according to the present invention further include moving means for moving the second separating medium, retaining the sample, to the first opening or the second opening.

With the foregoing structure, an electrophoresis apparatus according to the present invention realizes automated two-dimensional electrophoresis.

In an electrophoresis apparatus according to the present invention, it is preferable that the moving means move the second separating medium from the separating device to the first opening or the second opening.

With the foregoing structure, an electrophoresis apparatus according to the present invention realizes automated two-dimensional electrophoresis.

In an electrophoresis apparatus according to the present invention, it is preferable that the moving means move the first wiring means.

With the foregoing structure, an electrophoresis apparatus according to the present invention realizes automated two-dimensional electrophoresis.

In an electrophoresis apparatus according to the present invention, it is preferable that the moving means move the second wiring means.

With the foregoing structure, an electrophoresis apparatus according to the present invention realizes highly sophisticated automated two-dimensional electrophoresis.

With the present invention, once the electrophoresis is started, sensitive detection and quantitative analysis of separated sample are possible without involving complicated procedures.

### BRIEF DESCRIPTION OF DRAWINGS

FIG. 1 is a perspective view showing a main structure of an electrophoresis device according to one embodiment of the present invention.

FIG. 2 is a cross sectional view showing a main structure of the electrophoresis device according to one embodiment of the present invention.

FIG. 3 is a schematic view depicting a main structure of the electrophoresis device according to one embodiment of the present invention.

FIG. 4 is a cross sectional view depicting a main structure of the electrophoresis device according to one embodiment of the present invention.

FIG. 5 is a cross sectional view showing a main structure of an electrophoresis device according to one embodiment of the present invention.

FIG. 6 is a cross sectional view showing a main structure of the electrophoresis device according to one embodiment of the present invention.

FIG. 7 is a cross sectional view showing a main structure of the electrophoresis device according to one embodiment of the present invention.

FIG. 8 is a cross sectional view showing a main structure of the electrophoresis device according to one embodiment of the present invention.

FIG. 9 is a cross sectional view showing a main structure of an automated two-dimensional electrophoresis apparatus according to one embodiment of the present invention.

FIG. 10 is a cross sectional view showing a main structure of the automated two-dimensional electrophoresis apparatus according to one embodiment of the present invention.

FIG. 11 is a cross sectional view showing a main structure of the automated two-dimensional electrophoresis apparatus according to one embodiment of the present invention.

FIG. 12 is a cross sectional view showing a main structure of the automated two-dimensional electrophoresis apparatus according to one embodiment of the present invention.

FIG. 13 is a graph representing a result of CCD detection of excitation light that was reflected on a cassette surface in different kinds of cassette resin substrates.

FIG. 14 is a graph representing a relationship between protein mass of a sample applied on an electrophoresis device and detected fluorescence intensity.

### REFERENCE NUMERALS

1: lower substrate (first plate-insulator)
2: upper substrate (second plate-insulator)
3: anti-reflective layer
4: 2D gel (first separating medium)
4′: slit portion (first-separating-medium storing section)
5: first buffer chamber
6: second buffer chamber
7: first opening
8: second opening
9: light absorbing layer
10: insulator
30: irradiating means (irradiating section)
40: detecting means (fluorescence detecting section)
50: first voltage applying means
51: first wiring means
52: first electrode
53: second electrode
60: stage (fixing substrate)
70: 1D cell (separating device)
71: 1D separating chamber
72: 1D gel (second separating medium)
73: supporting plate
74: gel-equipped supporting plate
80: second voltage applying means
81: second wiring means
82: third electrode
90: arm
100: 2D cell (electrophoresis device)
101: 2D cell (electrophoresis device)
200: electrophoresis apparatus
201: two-dimensional electrophoresis apparatus

### BEST MODE FOR CARRYING OUT THE INVENTION

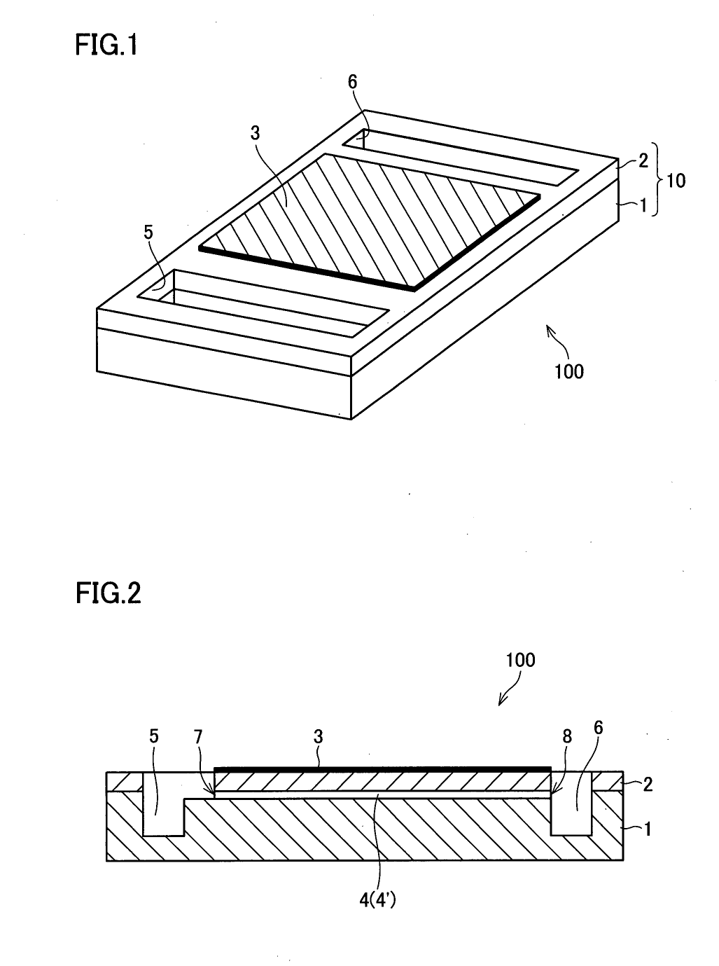

With reference to FIG. 1 through FIG. 4, the following will describe a first embodiment of an electrophoresis device according to the present invention. As an example, description will be made based on an electrophoresis device 100 that can be used as a 2D chip for two-dimensional electrophoresis (second-electrophoresis chip).

FIG. 1 is a perspective view illustrating a main structure of the electrophoresis device 100 according to one embodiment of the present invention. The electrophoresis device 100 of the present embodiment includes an insulator 10 made up of a lower substrate (first plate-insulator) 1 and an upper substrate (second plate-insulator) 2. The insulator 10 is provided with a slit portion (first-separating-medium storing section) 4′ that stores a first separating medium 4 to be subjected to the second electrophoresis. The insulator 10 also includes a first buffer chamber 5 and a second buffer chamber 6. The upper substrate 2 is covered with an anti-reflective layer 3. FIG. 2 is a cross section of the electrophoresis device 100 shown in FIG. 1.

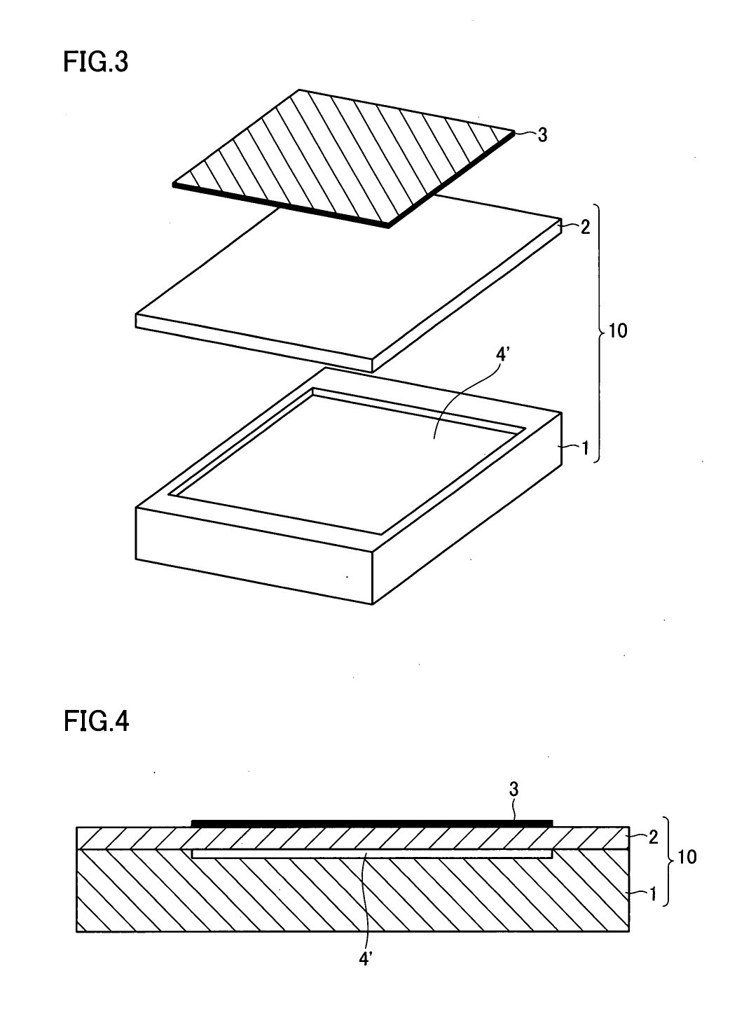

In order to fabricate the electrophoresis device 100, the lower substrate 1 with the slit portion 4′ on its upper surface is combined with the upper substrate 2, so that the insulator 10 covers the slit portion 4′. The insulator 10 is then coated with the anti-reflective layer 3 (see FIGS. 3 and 4). Thereafter, two grooves (first buffer chamber 5 and second buffer chamber 6) are formed in the lower substrate 1, penetrating through the upper substrate 2. The first separating medium 4 stored in the first-separating-medium storing section 4′ is in communication with outside of the insulator 10 through a first opening 7 and a second opening 8.

The first opening 7 and the second opening 8 face the first buffer chamber 5 and the second buffer chamber 6, respectively, of the electrophoresis device 100. For sample separation, the first buffer chamber 5 and the second buffer chamber 6 are filled with a first buffer and a second buffer, respectively, which, at the first opening 7 and the second opening 8, are in contact with the first separating medium 4 stored in the slit portion 4′ (not shown).

The term “sample” is a synonym for a specimen or a preparation in the art. As used herein, the “sample” refers to a “biological sample” or its equivalents. The “biological sample” means any preparation obtained from source biological materials (for example, individual organisms, body fluids, cell lines, cultured tissues, or tissue sections). Examples of such biological samples include body fluids (for example, blood, saliva, plaque, serum, blood plasma, urine, synovial fluid, and spinal fluid), and tissues. Preferably, biological samples are samples obtained from subjects. Such subject samples are preferably skin lesions, pharyngeal mucus, nasal mucus, pus, or secreted material. As used herein, “tissue samples” are intended to mean biological samples obtained from tissues. Methods of obtaining tissue samples and body fluids from mammals are known in the art. As used herein, the meaning of “sample” is not just limited to the biological samples and tissues samples as defined above, but it also encompasses protein samples, genomic DNA samples, and/or total RNA samples extracted from the biological samples and tissue samples.

When the protein (or DNA, etc.) of interest is fluorescence-labeled (or fluorescence-stained), fluorescence of the protein (or DNA, etc.) bands needs to be detected. In order for the protein (or DNA, etc.) to fluoresce, excitation light needs to have access to the protein (or DNA, etc.), and the generated fluorescence needs to be released out of the first separating medium.

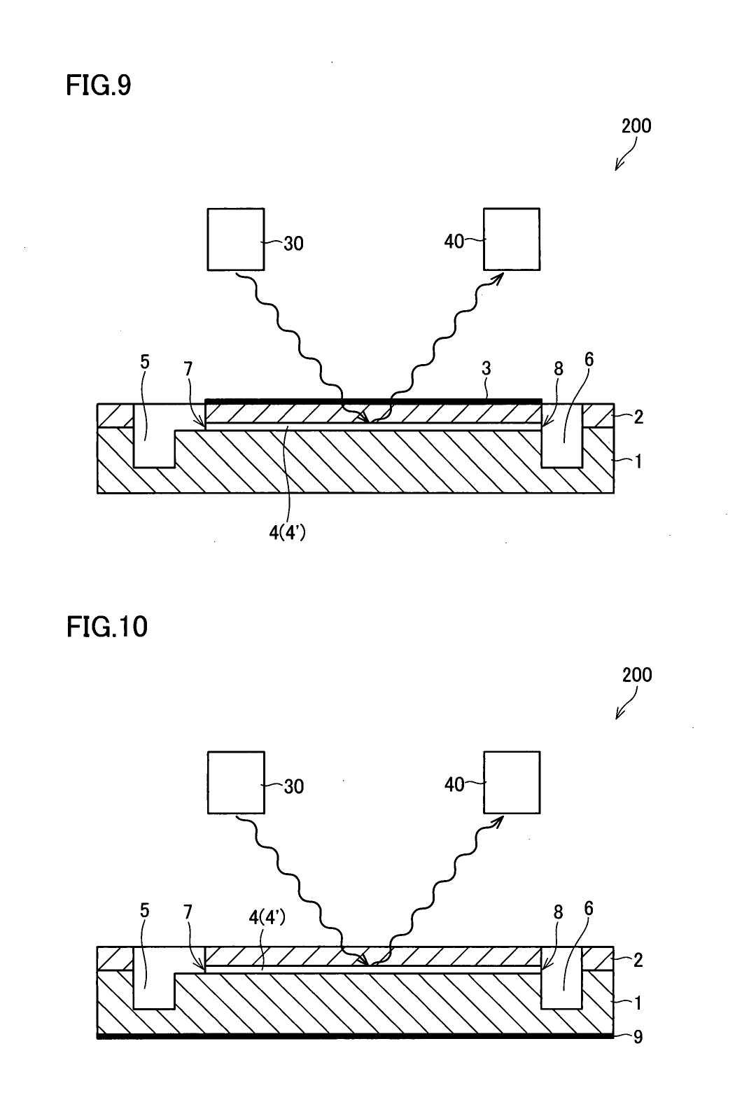

In the electrophoresis apparatus 100 of the present embodiment, observation of the first separating medium 4 is made from above, through the anti-reflective layer 3. As such, the upper substrate 2 is made of a light-transmissive material in a portion between the first-separating-medium storing section 4′ and the anti-reflective layer 3. In this case, there are provided irradiating means 30 for irradiating excitation light on the fluorescence-label of the protein (or DNA, etc.), and detecting means 40 for detecting the fluorescence emitted by the fluorescence material labeling the protein (or DNA, etc.). The irradiating means 30 and the detecting means 40 are preferably provided above the first separating medium 4, as shown in FIG. 9. The entire portion of the upper substrate 2 may be light-transmissive.

If the lower substrate 1 were light-transmissive, the irradiating means 30 and the detecting means 40 may be provided beneath the lower substrate 1 and the detection of the fluorescence emitted by the fluorescence material labeling the protein (or DNA, etc.) may be made by these irradiating means 30 and detecting means 40. That is, the irradiating means 30 and the detecting means 40 are suitably positioned according to the position of the anti-reflective layer 3 and the corresponding position of the light-transmissive portion.

The anti-reflective layer 3 preferably has a reflectance no greater than 5%, or more preferably no greater than 2%, with respect to at least the peak wavelength of excitation light. The anti-reflective layer 3 may be a layer made of a material with a small refractive index (small refractive index material), or a multi-layered film formed of materials with different refractive indices, including a small refractive index material, a material with a large refractive index (large refractive index material), and a material with an intermediate refractive index (intermediate refractive index material).

Non-limiting examples of a low refractive index material include silicon oxide and magnesium fluoride. Non-limiting examples of a large refractive index material include titanium oxide, niobate oxide, zinc oxide, and indium oxide. Non-limiting examples of an intermediate refractive index material include aluminum oxide. Preferably, the anti-reflective layer 3 is, for example, titanium oxide or silicon dioxide formed on the upper substrate 2, or a laminate of titanium oxide and silicon dioxide successively formed on the upper substrate 2 by the sputtering method. The anti-reflective layer 3 made of such materials may be formed either directly on the upper substrate 2 or by being formed on another base material which is later combined with the upper substrate 2.

The base material may be, for example, glass, a polyester resin film, a cellulose resin film, a polyolefin resin film, or a polycarbonate resin film. The materials as exemplified above may be formed on the base material by a dry method, in which the material is formed by a deposition or sputtering method, or a wet method, in which a solution containing the material is coated by a coating method.

The anti-reflective layer 3 preferably has a transmittance no less than 80%, or more preferably no less than 85%, with respect to the wavelength of excitation light. It is important to note that the reflectance needs to fall in the foregoing ranges in the direction of incidence of excitation light. It is therefore necessary that the optical design of the anti-reflective layer 3 be laid out taking into account the incident direction of excitation light.

In the present first embodiment, the light-transmissive portion desirably causes little reflection/absorption for the wavelength of exited light and the wavelength of fluorescence. Non-limiting examples of materials that can be suitably used for the light-transmissive portion include ceramic materials and plastic materials that are designed to cause little reflection/absorption for the wavelengths of excitation light and fluorescence. The entire portions of the lower substrate 1 and/or the upper substrate 2 may be light-transmissive. In this case, the lower substrate 1 and/or the upper substrate 2 are preferably made of glass, acrylic resin, or polyolefin resin, taking into account that these substrates have an insulating property. However, the material of the lower substrate 1 and the upper substrate 2 are not just limited to these examples.

In the electrophoresis device 100, current needs to be flown from the second opening 8 to the first opening 7. To this end, the insulator 10 needs to be in contact with the first separating medium 4 and insulate the first separating medium 4, except at the first opening 7 and the second opening 8. Further, since the liquid (buffers) needs to be retained in the first buffer chamber 5 and the second buffer chamber 6, the insulator 10 is preferably made waterproof. Non-limiting examples of such insulating materials include polyolefin, polyvinylchloride, and polyvinylidene chloride.

Though the invention has been described based on the electrophoresis device 100 in which the insulator 10, the first buffer chamber 5, and the second buffer chamber 6 are formed in one piece, these members may be separate components.

Preferably, the first separating medium 4 is in contact with the buffers only at the first opening 7 and the second opening 8. The insulator 10 is therefore preferably made of a highly waterproof material. Further, it is preferable that the insulator 10 be made of a highly light-transmissive material, in order to allow samples to be detected without having the first separating medium 4 removed from the insulator 10—a procedure required for the sensitive analysis performed after or during the electrophoresis. Examples of such materials include glass and resin, which may be acrylic resin, PDMS, polyolefin, polycarbonate, polystyrene, PET, or polyvinyl chloride. Among these examples, acrylic resin (polymethylmethacrylate (PMMA), for example) is preferable in terms of weight, operability, and productivity.

The first separating medium 4 may be formed directly in the first-separating-medium storing section 4′, or formed separately and fixed on the first-separating-medium storing section 4′. The first-separating-medium storing section 4′ is not necessarily required to be a slit. In this case, spacers (not shown) having the same thickness as the first separating medium 4 are placed around portions of the lower substrate 1 where the first separating medium 4 is to be fixed, and the lower substrate 1 and the upper substrate 2 are bonded together via the spacers.

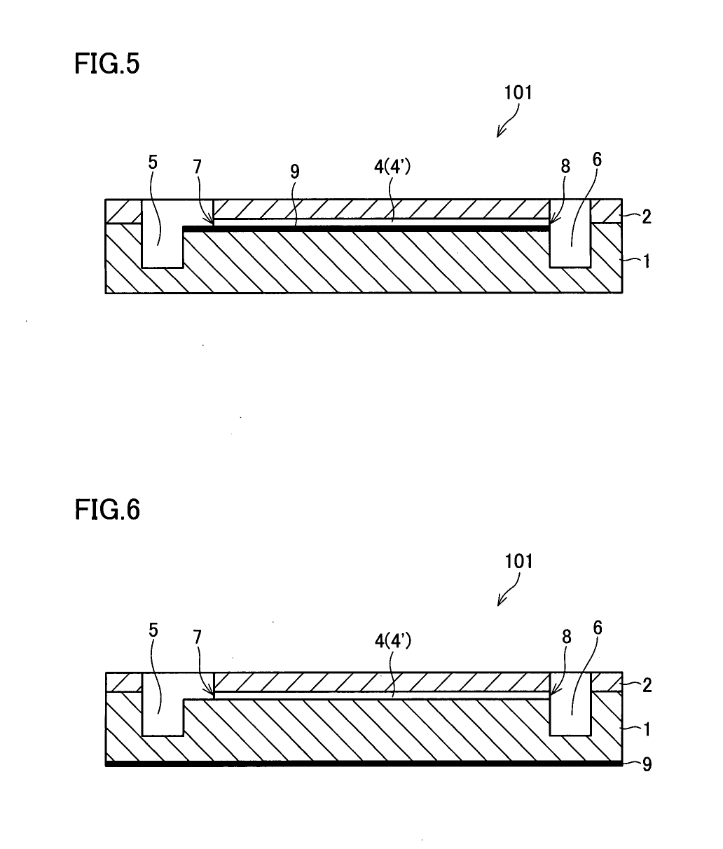

With reference to FIG. 5 through FIG. 8, the following will describe a second embodiment of an electrophoresis device according to the present invention. As an example, description will be made based on an electrophoresis device 101 that can be used as a 2D chip for two-dimensional electrophoresis (second electrophoresis chip).

FIG. 5 is a cross sectional view illustrating a main structure of the electrophoresis device 101 according to the present embodiment. The electrophoresis device 101 of the present embodiment includes an insulator 10 made up of a lower substrate (first plate-insulator) 1 and an upper substrate (second plate-insulator) 2. The insulator 10 is provided with a slit portion (first-separating-medium storing section) 4′ that stores a first separating medium 4 to be subjected to the second electrophoresis. The insulator 10 also includes a first buffer chamber 5 and a second buffer chamber 6.

In the second embodiment, the first separating medium 4 is observed from above, and as such a portion of the upper substrate 2 covering the first-separating-medium storing section 4′ is made of a light-transmissive material to constitute a light-transmissive portion, as in the first embodiment. In this case, there are provided irradiating means 30 for irradiating excitation light on the fluorescence material labeling the protein (or DNA, etc.), and detecting means 40 for detecting fluorescence emitted by the fluorescence material labeling the protein (or DNA, etc.). The irradiating means 30 and the detecting means 40 are preferably provided above the first separating medium 4, as shown in FIG. 9. The entire portion of the upper substrate 2 may be light-transmissive.

In the second embodiment, the electrophoresis device 101 further includes a light absorbing layer 9 on the lower substrate 1, which faces the light-transmissive portion via the first-separating-medium storing section 4′. Two grooves (first buffer chamber 5 and second buffer chamber 6) are formed in the lower substrate 1, penetrating through the upper substrate 2. The first separating medium 4 stored in the first-separating-medium storing section 4′ is in communication with outside of the insulator 10 through a first opening 7 and a second opening 8.

The first opening 7 and the second opening 8 face the first buffer chamber 5 and the second buffer chamber 6, respectively, of the electrophoresis device 101. For sample separation, the first buffer chamber 5 and the second buffer chamber 6 are filled with a first buffer and a second buffer, respectively, which, at the first opening 7 and the second opening 8, are in contact with the first separating medium 4 stored in the slit portion 4′ (not shown).

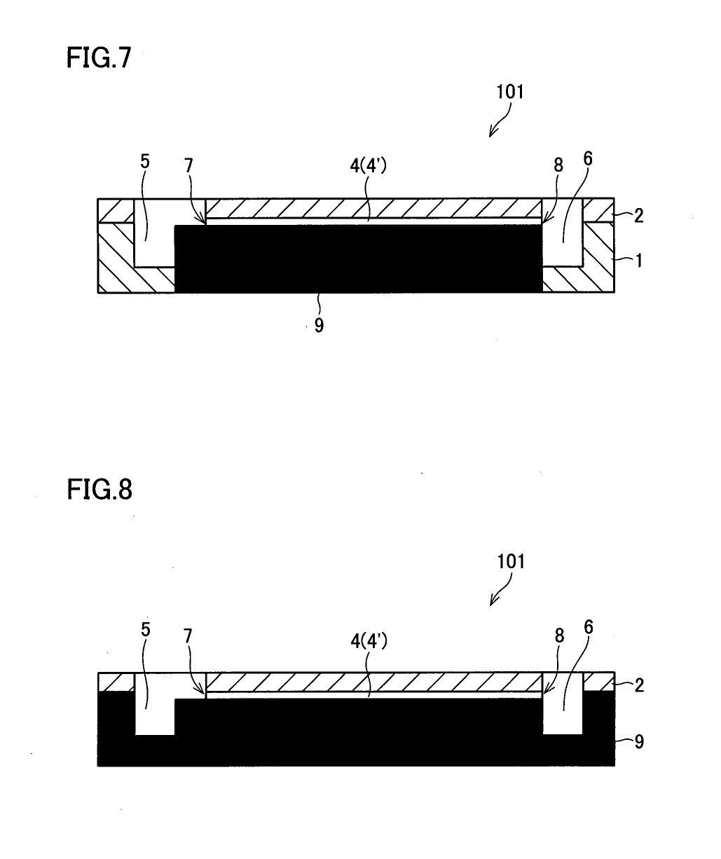

In the second embodiment, the light absorbing layer 9 may be provided directly below the first-separating-medium storing section 4′ of the lower substrate 1 (FIG. 5), or on the bottom surface of the lower substrate 1 (FIG. 6). Further, the light absorbing layer 9 may constitute the lower substrate 1 in a portion supporting the first-separating-medium storing section 4′ (FIG. 7). Alternatively, the light absorbing layer 9 may constitute the entire portion of the lower substrate 1 (FIG. 8).

Evidently, the lower substrate 1 may be provided with a light-transmissive portion, and the irradiating means 30 and the detecting means 40 may be provided beneath the lower substrate 1 to detect the fluorescence emitted by the fluorescence material labeling the protein (or DNA, etc.). In this case, the light absorbing layer 9 may constitute the upper substrate 2 in a portion covering the first-separating-medium storing section 4′, or the light absorbing layer 9 may constitute the entire portion of the upper substrate 2 (not shown). That is, the irradiating means 30 and the detecting means 40 are suitably positioned according to the position of the light-transmissive layer 3 and the corresponding position of the light absorbing layer 9.

The light absorbing layer 9 preferably has a transmittance no greater than 5%, or more preferably no greater than 2%, with respect to at least the peak wavelength of excitation light. For this purpose, a pigment or a dye having an absorption band in the peak wavelength of excitation light can be used. Specifically, a composition with a pigment or a dye included in a solvent or a resin binder may be formed by a wet method such as a coating method. In the case where the lower substrate 1 serves as the light absorbing layer 9, a pigment or a dye is also included in the substrate. The light absorbing layer 9 preferably has a transmittance no greater than 5%, or more preferably no greater than 2%, with respect to the fluorescence wavelength.

The insulator 10 and the light-transmissive portion as described in the second embodiment are essentially the same as those described in the first embodiment. Further, the electrophoresis device 101 has been described to include the insulator 10, the first buffer chamber 5, and the second buffer chamber 6 that are formed in one piece as illustrated in FIGS. 5 through 8; however, these members may be separate components.

As described above, according to one aspect of the invention, there are provided electrophoresis devices 100, 101, which include: a lower substrate 1 for retaining the first separating medium 4; a first buffer chamber 5 and a second buffer chamber 6, provided on both ends of the lower substrate 1, for reserving buffers; and an upper substrate 2 covering the lower substrate 1 and provided thereon with the anti-reflective layer 3.

In another aspect of the invention, there are provided electrophoresis devices 100, 101, which include: a lower substrate 1 for retaining the first separating medium 4; a first buffer chamber 5 and a second buffer chamber 6, provided on both ends of the lower substrate 1, for reserving buffers; and an upper substrate 2 covering the lower substrate 1, the lower substrate 1 being black in color or provided with a black layer 9.

In yet another aspect of the invention, there are provided electrophoresis devices 100, 101, which include: a lower substrate 1 for retaining the first separating medium 4; a first buffer chamber 5 and a second buffer chamber 6, provided on both ends of the lower substrate 1, for reserving buffers; and an upper substrate 2 covering the lower substrate 1 and provided with the anti-reflective layer 3, the lower substrate 1 being black in color or provided with a black layer 9.

In the electrophoresis devices 100, 101 according to the present invention, it is preferable that the first separating medium 4 be placed on the lower substrate 1.

In the electrophoresis devices 100, 101 according to the present invention, it is preferable that the first separating medium 4 be a gel material.

In the electrophoresis devices 100, 101 according to the present invention, the anti-reflective layer 3 may be titanium oxide or silicon dioxide formed on the upper substrate 2, or a laminate of titanium oxide and silicon dioxide successively formed on the upper substrate 2 by the sputtering method.

Because the transmitted wavelength has a certain spectrum, modifying the detecting means (for example, using a fluorescent filter for a CCD camera) is not enough to completely block the excitation light when observing fluorescence. The present invention, with the foregoing structure, can properly eliminate reflected light and/or scattered light generated by the cassette, and therefore allows for detection and/or analysis of protein (or DNA, etc.) using a fluorescence material whose fluorescence wavelength is close to the wavelength of excitation light.

Further, the present invention does not require removing the gel. This prevents the gel form being dried and/or deformed, and allows for analysis on a low noise background without washing the gel, which is necessitated when the gel is removed.

Further, the protein (or DNA, etc.) spots can be prevented from being spread, which may occur after voltage has been applied (when the electrophoresis is finished).

At the end of voltage application (when the electrophoresis is finished), an end marker of electrophoresis, such as a pigment marker, a dye, or a fluorescent pigment that failed to label the sample has been separated on one end of the gel (low molecular weight side). By thus preventing these substances from contacting the gel after the sample separation, the analysis can be made without errors.

With reference to FIG. 9 or 10, the following will describe one embodiment of an electrophoresis apparatus according to the present invention.

FIG. 9 is a cross sectional view illustrating one embodiment of an electrophoresis apparatus 200 equipped with the electrophoresis device 100 of the first embodiment of the present invention. In addition to the electrophoresis device 100, the electrophoresis apparatus 200 according to the present invention includes irradiating means 30 and detecting means 40. In the present embodiment, the electrophoresis device 100 includes an insulator 10 made up of a lower substrate (first plate-insulator) 1 and an upper substrate (second plate-insulator) 2. The insulator 10 is provided with a slit portion (first-separating-medium storing section) 4′ that stores a first separating medium 4 to be subjected to the second electrophoresis. The insulator 10 also includes a first buffer chamber 5 and a second buffer chamber 6. The upper substrate 2 is coated with an anti-reflective layer 3. The first separating medium 4 stored in the first-separating-medium storing section 4′ is in communication with outside of the insulator 10 through a first opening 7 and a second opening 8.

The first opening 7 and the second opening 8 face the first buffer chamber 5 and the second buffer chamber 6, respectively, of the electrophoresis device 101. For sample separation, the first buffer chamber 5 and the second buffer chamber 6 are filled with a first buffer and a second buffer, respectively, which, at the first opening 7 and the second opening 8, are in contact with the first separating medium 4 stored in the slit portion 4′ (not shown).

In the electrophoresis apparatus 200 according to the present invention, the irradiating means 30 irradiates the electrophoresis device 100 with excitation light, and the detecting means 40 detects the fluorescence of the fluorescence-labeled sample. As such, the upper substrate 2 constitutes a light-transmissive portion made of a light-transmissive material in a portion between the first-separating-medium storing section 4′ and the anti-reflective layer 3. Preferably, the entire portion of the upper substrate 2 is light-transmissive.

In the electrophoresis apparatus 200 according to the present embodiment, the irradiating means 30 and the detecting means 40 are capable of sensitive detection and provide a sharp detection image even for a trace amount of protein (or DNA, etc.), by utilizing the characteristics of the anti-reflective layer 3 (and/or the lower substrate 1). To describe more specifically, a trace amount of sample has conventionally been detected by extending the exposure time and thereby improving the detection intensity for a signal that cannot be readily distinguished from background noise. According to the present embodiment, even a short detection time can provide a high S/N ratio (signal S:fluorescence, noise N:excitation light) and enables sensitive detection.

FIG. 10 is a cross sectional view illustrating one embodiment of an electrophoresis apparatus 200 equipped with the electrophoresis device 101 of the second embodiment of the present invention. In addition to the electrophoresis device 101, the electrophoresis apparatus 200 according to the present invention includes irradiating means 30 and the detecting means 40. In the present embodiment, the electrophoresis device 101 includes an insulator 10 made up of a lower substrate (first plate-insulator) 1 and an upper substrate (second plate-insulator) 2. The insulator 10 is provided with a slit portion (first-separating-medium storing section) 4′ that stores a first separating medium 4 to be subjected to the second electrophoresis. The insulator 10 also includes a first buffer chamber 5 and a second buffer chamber 6. The electrophoresis device 101 further includes a light-absorbing layer 9 on the lower substrate 1. The first separating medium 4 stored in the first-separating-medium storing section 4′ is in communication with outside of the insulator 10 through a first opening 7 and a second opening 8.

The first opening 7 and the second opening 8 face the first buffer chamber 5 and the second buffer chamber 6, respectively, of the electrophoresis device 101. For sample separation, the first buffer chamber 5 and the second buffer chamber 6 are filled with a first buffer and a second buffer, respectively, which, at the first opening 7 and the second opening 8, are in contact with the first separating medium 4 stored in the slit portion 4′ (not shown).

In the electrophoresis apparatus 200 according to the present invention, the irradiating means 30 irradiates the electrophoresis device 101 with excitation light, and the detecting means 40 detects the fluorescence of the fluorescence-labeled sample. As such, the upper substrate 2 constitutes a light-transmissive portion made of a light-transmissive material between the first-separating-medium storing section 4′ and the anti-reflective layer 3. Preferably, the entire portion of the upper substrate 2 is light-transmissive.

In the electrophoresis apparatus 200 according to the present embodiment, the irradiating means 30 and the detecting means 40 allow for sensitive detection even for proteins (or DNA, etc.) being moved, by utilizing the characteristics of the anti-reflective layer 3 (and/or the lower substrate 1).

The irradiating means 30 irradiates excitation light on the fluorescence-labeled sample that is separated and developed in the first separating medium 4, and the detecting means 40 detects fluorescence generated by the sample. In this way, an operator using the electrophoresis apparatus 200 does not need to touch the gel. Further, the electrophoresis apparatus 200 according to the present embodiment allows for sensitive detection with a high S/N ratio in a short exposure time. Therefore, detection can be made without having been required to stop voltage application during electrophoresis.

The proteins (or DNA, etc.) irradiated by the irradiating means are preferably stained, or more preferably fluorescence-stained, beforehand.

Conventionally, fluorescent-labeled proteins (or DNA, etc.) in the gel have been detected after the electrophoresis (with the proteins (or DNA, etc.) not moving), by observing the irradiated light directly above the gel that has been irradiated with it directly from above. However, with a detection device having such a structure, it is very difficult to detect proteins (or DNA, etc.) during electrophoresis. This is because sensitive detection of the target protein (or DNA, etc.) requires a long exposure time, giving the sample time to move and as a result causing detection of unclear separation. This has made the analysis practically impossible.

The electrophoresis apparatus 200 according to the present invention includes control means (not shown) for properly controlling operations of the irradiating means 30 and the detecting means 40, and processing collected data. The control means according to the present embodiment includes a control unit with a plurality of functional elements, such as an arithmetic section, a memory section, and a processing section. The memory section of the control means stores a program that executes the arithmetic operations performed by the processing section. The memory section also stores collected data, which is supplied to the processing section as required. The control is realized as the control unit causes the arithmetic section to execute the program stored in the memory section and thereby controls an input/output circuit and other peripheral circuits (not shown). Non-limiting examples of such peripheral circuits include: a storing section for storing various pre-set values (for example, excitation wavelength/fluorescence wavelength of the fluorescence material used); a comparing section for comparing detected values with the stored values; and a circuit provided between, for example, processing sections which, based on the result of comparison, calculate an output used to control, for example, moving means. All of these functional blocks are under the control of the arithmetic sections. Specific structures and functions of these functional blocks are not particularly limited.

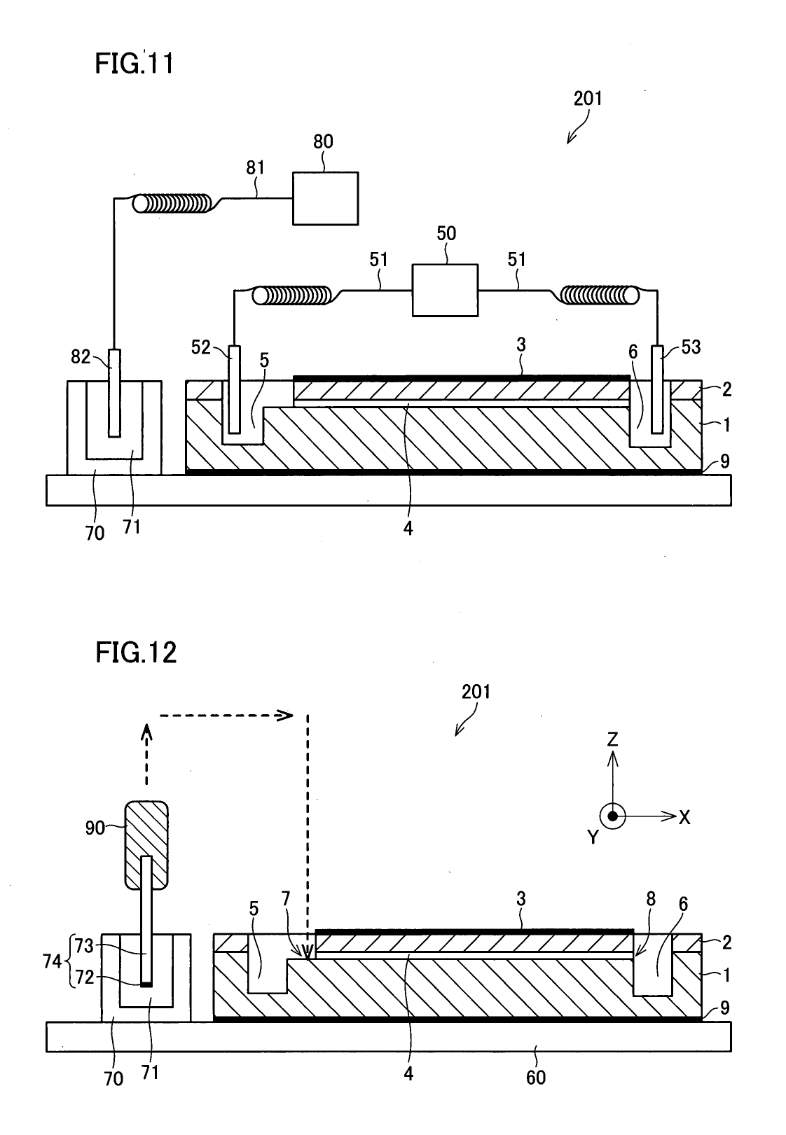

FIG. 11 is a cross sectional view illustrating a two-dimensional electrophoresis apparatus 201 provided with voltage applying means for applying voltage in two-dimensional electrophoresis that is performed with an electrophoresis device 102, which has the features of the electrophoresis devices 100, 101 and used in combination with a separating device 70.

In the electrophoresis actually performed by the electrophoresis apparatus 201, first voltage applying means 50 applies voltages to the first separating medium 4 via a first electrode 52 and a second electrode 53 respectively inserted in the first buffer chamber 5 and the second buffer chamber 6, as shown in FIG. 11. As a result, current is flown through the second opening 8 toward the first opening 7, and the sample that has been applied on the first separating medium 4 develops/separates as it moves from the first opening 7 toward the second opening 8.

In the electrophoresis apparatus 201 according to the present embodiment, the first electrode 52 and the second electrode 53, respectively inserted in the first buffer chamber 5 and the second buffer chamber 6, are connected to the first voltage applying means 50 via wiring means 51. The first electrode 52 and the second electrode 53 may be fixed on the first buffer chamber 5 and the second buffer chamber 6, respectively. However, considering that the first electrode 52 and the second electrode 53 are replaced for each different sample using the electrophoresis device 102, it is more preferable not to fix the first electrode 52 and the second electrode 53. In the case where the wiring means 51 is movable by the moving means (not shown), the first electrode 52 and the second electrode 53 may be detachably provided on electrode fixing sections (not shown) respectively provided for the first buffer chamber 5 and the second buffer chamber 6. This makes it easier to wash the first electrode 52 and the second electrode 53.

In performing two-dimensional electrophoresis with the electrophoresis apparatus 201, the separating device 70 serves as a 1D cell for performing the first separation, and the electrophoresis device 100 serves as a 2D cell for performing the second separation.

As shown in FIG. 11, the two-dimensional electrophoresis apparatus 201 according to the present embodiment is provided with the 2D cell (electrophoresis device) 100 and the 1D cell (separating device) 70. The 2D cell 100 includes: an insulator 10 made up of a lower substrate 1 and an upper substrate 2; an anti-reflective layer 3 provided on the upper substrate 2; a light absorbing layer 9 provided on the bottom surface of the lower substrate 1; and a slit portion 4′, provided in the lower substrate 1, which stores a first separating medium 4 to be subjected to two-dimensional electrophoresis.

In the electrophoresis apparatus 201, the 1D cell 70 includes a 1D separating chamber 71 where the electrophoresis is actually performed. In the 1D separating chamber 71, a second voltage applying means 80 applies voltage to a 1D gel (second separating medium) (not shown) via a third electrode 82, as shown in FIG. 11. As a result, the sample that has been applied to the 1D gel develops/separates in the direction perpendicular to the plane of paper in FIG. 11.

In the two-dimensional electrophoresis apparatus 201 according to the present embodiment, the first electrode 52 and the second electrode 53 are connected to the first voltage applying means 50 via the wiring means 50, and the third electrode 82 is connected to the second voltage applying means 80 via second wiring means 81. The first electrode 52 and the second electrode 53 are respectively inserted in the first buffer chamber 5 and the second buffer chamber 6, and the third electrode 82 is inserted in the 1D separating chamber 71.

The first electrode 52 and the second electrode 53 may be fixed on the first buffer chamber 5 and the second buffer chamber 6, respectively. However, considering that the first electrode 52 and the second electrode 53 are replaced for each different sample using the 2D cell 100, it is more preferable not to fix the first electrode 52 and the second electrode 53. In the case where the wiring means 51 is movable by the moving means (not shown), the first electrode 52 and the second electrode 53 may be detachably provided on electrode fixing sections (not shown) respectively provided for the first buffer chamber 5 and the second buffer chamber 6. Further, as shown in FIG. 8, the first electrode 52 and the second electrode 53 may simply be inserted in the buffers filling the first buffer chamber 5 and the second buffer chamber 6, respectively.

As with the first electrode 52 and the second electrode 53, the third electrode 82 may be fixed on the 1D separating chamber 71. However, considering that the third electrode 82 is replaced for each different sample using the 1D cell 70 and the 2D cell 100, it is more preferable not to fix the third electrode 82. In the case where the wiring means 51 is movable by the moving means (not shown), the third electrode 82 may be detachably provided on an electrode fixing section (not shown) provided for the 1D separating chamber 71. Further, as shown in FIG. 8, the third electrode 82 may simply be inserted in the buffer filling the 1D separating chamber 71.

It is easier to wash the first electrode 52, the second electrode 53, and the third electrode 82 when these electrodes are movable rather than being fixed. Further, for automation of the apparatus, the 1D cell 70 and the 2D cell 100 should preferably be fixed on a stage (fixing substrate) 60.

FIG. 12 illustrates a main part of a structure for automating the steps performed by the two-dimensional electrophoresis apparatus 201 according to the present embodiment. The two-dimensional electrophoresis apparatus 201 according to the present embodiment includes a 2D cell (electrophoresis device) 100 and a 1D cell (separating device) 70. The 2D cell 100 includes: an insulator 10 made up of a lower substrate 1 and an upper substrate 2; an anti-reflective layer 3 provided on the upper substrate 2; a light absorbing layer 9 provided on the bottom surface of the lower substrate 1; and a slit portion 4′, provided in the lower substrate 1, which stores a first separating medium 4 to be subjected to the second electrophoresis.

As shown in FIG. 12, a 1D gel 72 and a support plate 73 are bonded together to form a gel-equipped support plate 74. The 1D gel, which is commercially available, has a transparent resin sheet, 0.2 mm thick, attached on the rear surface. The 1D gel 72 is bonded to the support plate 73 on this sheet portion, using an adhesive. Here, any adhesive known in the art can be used. However, since the 1D gel 72 bonded with the support plate 73 should preferably be preserved at low temperatures (−20° C.) till it is used, it is preferable to use an adhesive that is suited for low-temperature preservation. Such temperature characteristics are also desired for the support plate 73. The support plate 73 is held by an arm 90 that is driven by the moving means (not shown) of the two-dimensional electrophoresis apparatus 201 according to the present embodiment. By the moving means (not shown), the arm 90 is movable along X direction and/or Z direction, as shown in FIG. 12.

In the first buffer chamber 5, the opening made through the upper substrate 2 is greater in width than the corresponding groove formed in the lower substrate 1. By the width difference, a sample supply opening is formed where the 1D gel 72 is brought into contact with the 2D gel 4, enabling the second separation to be properly performed for the sample in the 1D gel 72 that has undergone the first separation in the 1D separating chamber 71. In the present embodiment, the first opening 7 serves as the sample supply opening, as shown in FIG. 12.

As shown in FIG. 12, two-dimensional electrophoresis is performed from left to right. The following will describe each step performed by the two-dimensional electrophoresis apparatus 201.

First, all the samples, reagents, and separating medium required for the two-dimensional electrophoresis are set in predetermined positions, and the control means (not shown) appropriately controls respective means of the two-dimensional electrophoresis apparatus 201 to perform each step by automation. Under the control of the control means, the moving means (not shown) is driven to move (transport) the arm 90 and thereby indirectly move (transport) the 1D gel 72.

The 1D gel 72, having been subjected to necessary treatment for the first sample separation is transported to the second separating chamber 71 and placed between the third electrodes 82 therein. Here, the second voltage applying means 80 applies voltage to the 1D gel 72 and the sample in the 1D gel 72 is separated in the first direction. Information concerning time and voltage required for sample separation is stored in the storing section of the control means. The information is suitably selected and executed according to the program stored in the storing section of the control means, depending on the types of 1D gel 72, samples, and reagents used.

After the separation in the first direction has been finished in the 1D gel 72, the 1D gel 72 is transported by the moving means to a predetermined position where the 1D gel 72 is subjected to a necessary post-treatment of the first sample separation (prior to the second sample separation). As required, the 1D gel 72 is shaken gently. After the treatment, the 1D gel 72 is transported by the moving means to the sample supply opening 7 of the 2D gel 4, where the 1D gel 72 is brought into contact with the 2D gel 4.

With the 1D gel 72 in contact with the 2D gel 4, the first voltage applying means 50 applies voltage to the 2D gel 4. As a result, the sample that has been separated in the first direction in the 1D gel 72 is further separated in the 2D gel 4 in the second direction (to the right along the X axis), different from the first direction (Y direction). In order to realize the sample separation in the second direction, the following steps are performed in the 2D cell 4: a step in which the sample that has been separated in the first direction is brought into contact with the 2D gel 4; a step in which voltage is applied to the 2D gel 74 to separate the sample in the second direction; and a step in which the sample is detected as it is being separated in the second direction.

The time and other necessary information for the separation in the 2D gel 4 is also stored in the storing section of the control means. The information is suitably selected and executed according to the program stored in the storing section of the control means, depending on the types of 2D gel 4, samples, and reagents used.

The irradiating means 30 and the detecting means 40 allow the state of sample separation to be sensitively analyzed while the sample is being separated in the second direction, after or during the electrophoresis. As required, voltage application to the 2D gel 4 by the first voltage applying means 50 is stopped, and fluorescence-labeled protein (or DNA, etc.) bands at target positions are cut out by cutting means (not shown).

The storing section of the control means also stores information such as characteristics of the fluorescence material used. The information is suitably selected and executed according to the program stored in the storing section of the control means, depending on the types of 1D gel 72 and 2D gel 4, the types of lower substrate 1 and/or anti-reflective layer 3, the type of light absorbing layer 9, the type of sample, and the type of reagent.

In the two-dimensional electrophoresis apparatus 201, the sample is separated in the first direction in the 1D gel 72, and in the second direction in the 2D gel 4. The parameters that define the separation may be the same in the first direction and the second direction. However, for improved separation, it is preferable to set different parameters for the first direction and the second direction. Examples of parameters that define the separation in these two directions include: an isoelectric point of protein; molecular weight, surface charge (zone electrophoresis) per unit size; distribution coefficient for a micelle (micelle electrokinetic chromatography); distribution coefficient for stationary phase-mobile phase (electrical chromatography); and affinity constant for interacting substances (affinity coupling electrophoresis). Common two-dimensional electrophoresis uses an isoelectric point for the separation in the first direction, and a molecular weight for the separation in the second direction.

Considering that the 1D cell 70 and the 2D cell 100 are replaced for each different sample, it is preferable that the 1D cell 70 and the 2D cell 100 be fixed detachably. The mechanism for fixing the 1D cell 70 and the 2D cell 100 on the stage (fixing substrate) 60 may be, but are not limited to, a vacuum suction mechanism, a narrow fixing mechanism, a magnetic force fixing mechanism, or an electrostatic absorption mechanism. Similarly, it is preferable that the gel-equipped support plate 74 be detachably held by the arm 90. When using a vacuum suction mechanism, it is preferable that the 1D cell 70 and the 2D cell 100 be fixed via a vacuum suction plate (not shown).

In the electrophoresis apparatus 201, three-dimensional position accuracy of the gel-equipped plate 74 is important. Under the control of the control means (not shown) provided in the electrophoresis apparatus 201, the arm 90 is accurately moved to accurately perform various steps on the 1D gel 72. In the case where the electrodes 52, 53, and 82 are transported/fixed by automation, the arm 90 may be adapted to transport/fix the electrodes 52, 53, and 82 to/on the first buffer chamber 5, the second buffer chamber 6, and the 1D separating chamber 71, respectively, under the control of the control means.

Since the electrophoresis is performed under high voltage, the 1D cell 70 and the 2D cell 100 rise to high temperatures during sample separation. For this reason, the two-dimensional electrophoresis apparatus 201 is provided with cooling means (not shown), directly below the stage 60, for cooling the 1D cell 70, the 2D cell 100, and the stage 60 on which the 1D cell 70 and the 2D cell 100 are fixed. Specifically, in the two-dimensional electrophoresis apparatus 201, the temperatures of the 1D cell 70 and the 2D cell 100 can be maintained constant during electrophoresis by the provision of Peltier cooling control mechanism.

Further, the two-dimensional electrophoresis apparatus 201 according to the present invention may further include, for example, temperature control means (not shown) for controlling temperatures of the 1D gel 72 and the 2D gel 4. In this way, a more sophisticated sample separation is possible, though not shown.

As described above, in the two-dimensional electrophoresis apparatus 201, the steps of the two-dimensional electrophoresis can be performed by full automation under the control of the control means. Further, by the provision of the control means capable of executing the foregoing control, the two-dimensional electrophoresis apparatus 201 allows for easy selection and/or adoption of various protocols to pursue best sample separating performance. Further, a two-dimensional high-voltage application control system may be adopted that causes a computer to perform feedback control of a voltage application program for two-dimensional electrophoresis, and this system may be controlled along with the automated stage.

As described above, according to one aspect of the invention, there are provided electrophoresis devices 200, 201, which include: a lower substrate 1 for retaining the first separating medium 4; a first buffer chamber 5 and a second buffer chamber 6, provided on the both ends of the lower substrate 1, respectively including an electrode 52 and an electrode 53 and reserving buffers; an upper substrate 2 provided on the first separating medium 4 that is retained by the lower substrate 1; and the anti-reflective layer 3 provided on the upper substrate 2, the first buffer chamber 5 and the second buffer chamber 6 being filled with buffers.

According to another aspect of the invention, there are provided electrophoresis devices 200, 201, which include: a lower substrate 1 for retaining the first separating medium 4; a first buffer chamber 5 and a second buffer chamber 6, provided on the both ends of the lower substrate 1, respectively including an electrode 52 and an electrode 53 and reserving buffers; and an upper substrate 2 provided on the first separating medium 4 that is retained by the lower substrate 1, which is black in color or provided with a black layer 9, the first buffer chamber 5 and the second buffer chamber 6 being filled with buffers.

According to yet another aspect of the invention, there are provided electrophoresis devices 200, 201, which include: a lower substrate 1 for retaining the first separating medium 4; a first buffer chamber 5 and a second buffer chamber 6, provided on the both ends of the lower substrate 1, respectively including an electrode 52 and an electrode 53 and reserving buffers; and an upper substrate 2 provided on the first separating medium 4 that is retained by the lower substrate 1; and an anti-reflective layer 3 provided on the upper substrate 2, the lower substrate 1 being black in color or provided with a black layer 9, the first buffer chamber 5 and the second buffer chamber 6 being filled with buffers.

The electrophoresis apparatus 200, 201 according to the present invention includes an irradiating section 30 and a fluorescence detecting section 40, preferably above the upper substrate 2.

In the electrophoresis apparatus 200, 201 according to the present invention, the first separating medium 4 is preferably a gel material.

In the electrophoresis apparatus 200, 201 according to the present invention, the anti-reflective layer 3 may be titanium oxide or silicon dioxide formed on the upper substrate 2, or a laminate of titanium oxide and silicon dioxide successively formed on the upper substrate 2 by the sputtering method.

With the human genome project proceeded to completion, there has been active research in proteomes. By “proteomes,” it encompasses all proteins translated in specific cells, organs, and internal organs. One area of proteome research is protein profiling.

A technique that is most commonly used for protein profiling is the two-dimensional electrophoresis of protein. Proteins have unique properties in charge and molecular weight. Therefore, the resolution of protein separation can be improved for large numbers of proteins if individual proteins in the proteome, which is a collection of large numbers of proteins, were separated based on a combination of charge and molecular weight, rather than charge or molecular weight alone.

The two-dimensional electrophoresis is a two-step process. The first step is the isoelectric point electrophoresis in which proteins are separated based on charge. The second step is the slab gel electrophoresis (particularly, SDS-PAGE), in which proteins are separated based on molecular weight. The two-dimensional electrophoresis is a superior technique in the sense that it can be performed in the presence or absence of a denaturing agent for the sample, and that it can separate more than several hundred kinds of proteins at once.

The two-dimensional electrophoresis proceeds by performing the isoelectric point electrophoresis for the sample on the first gel. This is followed by taking out the first gel and applying it onto the second gel, where the second separation is made based on molecular weight. Generally, the first gel used for the isoelectric electrophoresis is considerably thin, relative to width and length. This makes it difficult to distinguish the front and the back of the gel, or identify the direction of pH gradient. Further, since the first gel with such profiles is prone to bending or twisting, it is difficult to maintain the shape of the gel constant. This can cause problems in reproducibility of electrophoresis results. Further, the first gel is not easy to handle, and it is difficult to improve position accuracy in applying the first gel onto the second gel.

As described thus far, while the two-dimensional electrophoresis is a superior technique, it requires skill. Because it is skill dependent, it is difficult in the two-dimensional electrophoresis to yield quantitative data with good reproducibility.

With the present invention, however, the steps of the two-dimensional electrophoresis can be carried out by full automation, and quantitative data can be obtained with good reproducibility.

The foregoing detailed description described the present invention in relation to the electrophoresis device and the electrophoresis apparatus. However, it will be apparent by a person ordinary skill in the art that the invention also provides a method for separating proteins (electrophoresis method for proteins).

Specifically, according to one aspect of the present invention, the invention provides a method for separating proteins, including the steps of:

having a lower substrate 1 retain a first separating medium 4 that includes a fluorescence-stained protein reagent, the lower substrate 1 being provided in an electrophoresis device 100, 101 that includes a first buffer chamber 5 and a second buffer chamber 6, provided on the both ends of the lower substrate 1, for reserving buffers;

placing an upper substrate 2, provided with an anti-reflective layer 3, on the first separating medium 4;

filling the first buffer chamber 5 and the second buffer chamber 6 with buffers;

placing an electrode 52 and an electrode 53 in the first buffer chamber 5 and the second buffer chamber 6, respectively;

separating proteins by electrophoresis; and

detecting the proteins as they are being separated or after having been separated, using an irradiating section 30 and a fluorescence detecting section 40 that are provided above the upper substrate 2.

It is preferable that the irradiating section 30 irradiates light of a specific wavelength that can excite the fluorescence material.

According to another aspect of the present invention, the invention provides a method for separating proteins, including the steps of:

having a lower substrate 1 retain a first separating medium 4 that includes a fluorescence-stained protein reagent, the lower substrate 1 being black in color or being provided with a black layer 9, and being provided in an electrophoresis cassette that includes a first buffer chamber 5 and a second buffer chamber 6, provided on the both ends of the lower substrate 1, for reserving buffers;

placing an upper substrate 2, provided with an anti-reflective layer 3, on the first separating medium 4;

filling the first buffer chamber 5 and the second buffer chamber 6 with buffers, and placing an electrode 52 and an electrode 53 in the first buffer chamber 5 and the second buffer chamber 6, respectively;

separating proteins by electrophoresis; and

detecting the proteins as they are being separated or after having been separated, using an irradiating section 30 and a fluorescence detecting section 40 that are provided above the upper substrate 2.

It is preferable that the irradiating section 30 irradiates light of a specific wavelength that can excite the fluorescence material.

According to yet another aspect of the present invention, the invention provides a method for separating proteins, including the steps of:

having a lower substrate 1 retain a first separating medium 4 that includes a fluorescence-stained protein reagent, the lower substrate 1 being black in color or being provided with a black layer 9, and being provided in an electrophoresis cassette that includes a first buffer chamber 5 and a second buffer chamber 6, provided on the both ends of the lower substrate 1, for reserving buffers;

placing an upper substrate 2, provided with an anti-reflective layer 3, on the first separating medium 4;

filling the first buffer chamber 5 and the second buffer chamber 6 with buffers, and placing an electrode 52 and an electrode 53 in the first buffer chamber 5 and the second buffer chamber 6, respectively; and

separating proteins by electrophoresis, and detecting the proteins as they are being separated or after having been separated, using an irradiating section 30 and a fluorescence detecting section 40 that are provided above the upper substrate 2.

It is preferable that the irradiating section 30 irradiates light of a specific wavelength that can excite the fluorescence material.

In the method for separating proteins according to the present invention, it is preferable that the first separating medium 4 be a gel material.

The embodiments of implementation discussed in the foregoing detailed explanation and concrete examples discussed below serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

It is noted that the entire contents of the academic journals and patent publications cited in the description of the specification are hereby incorporated by reference.

### EXAMPLE 1

A first separating medium (2D gel) of polyacrylamide (45 mm×80 mm×1 mm: direction of electrophoresis×width×thickness) was prepared. On a surface at one end of the gel, a sample apply section was provided according to ordinary method. As the electrophoresis device, a cassette made of glass, PMMA, or PVC was used (60 mm×100 mm×5.5 mm: direction of electrophoresis×width×thickness). The cassette had a first-separating-medium storing section, 1 mm thick, provided with spacers, 10 mm each, disposed along the width direction. As an example provided with an anti-reflective layer, a sheet with the anti-reflective layer was attached on the cassette so as to cover the first separating medium. As an example provided with a light absorbing layer, the rear surface of the cassette was sprayed with a black paint. As an example provided with both the anti-reflective layer and the light absorbing layer, a sheet with the anti-reflective layer was attached on the cassette so as to cover the first separating medium, and the rear surface of the cassette was sprayed with a black paint.

As a sample to be separated, molecular weight markers (SIGMA) were used. Prior to the electrophoresis, the sample was fluorescence labeled with Cy5 (Amersham biosciences), according to the manufacturer's protocol. The fluorescence-labeled sample was then injected into the sample apply section, and was electrophoresed under applied constant voltage of 200 V for 20 minutes.

As the irradiating means, a xenon light source with an excitation light wavelength of 620 nm was disposed at a 45 degree angle with respect to the observed surface of the cassette. As the detecting means, a CCD camera with a fluorescence filter (680 nm) was disposed in a direction normal to the observed surface of the cassette. These detection systems were used to capture images of the resin substrate in the polyacrylamide portion, where the separated sample was present and not present.

As described above, excitation light was incident on the cassette at a 45 degree angle, and images were taken with a CCD camera (fluorescence filter, 680 nm) in a direction normal to the cassette surface. As a result, the following intensities of light were observed on the resin substrate. The observed light was excitation light that was reflected/scattered between the cassette resin substrate and the air layer above the stage. The light generates background values when observing the fluorescent sample through the cassette, and adds to the intensity value of the fluorescence in each spot to be observed.

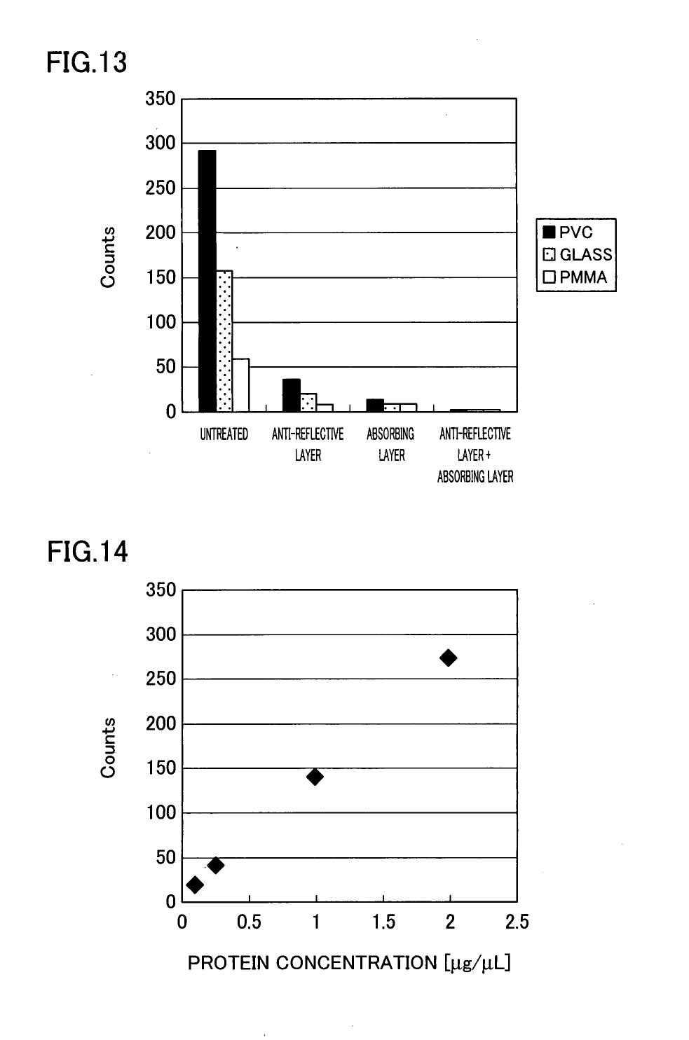

Results of experiment using these substrates showed that reflection/scattering of excitation light was absorbed and the background value decreased when a black light-absorbing layer was provided on the rear surface of the substrate. FIG. 13 represents results of CCD detection of excitation light (620 nm) that was reflected on the cassette surface. The results showed that similar effects could be obtained in each type of cassette.

In protein spots, fluorescence-labeled proteins are known to exhibit fluorescence intensities that are proportional to the concentrations. In the 2D electrophoresis, all of the separated spots are small. That is, most of the separated proteins are small in quantity.

In the detection using conventional cassettes, the values of fluorescence intensities often fall within a range of background noise (fluctuations), with the result that fluorescence was not detected despite the presence of spots.

By the provision of the anti-reflective layer and/or the light absorbing layer, an electrophoresis device according to the present invention is able to detect proteins even when the protein sample was applied in an amount of 0.1 μg/μL or less (see FIG. 14).

The light absorbing layer provided in an electrophoresis device according to the present invention also absorbs the scattered light that occurs due to the fluorescence generated by high-concentration proteins with large spot intensities. An electrophoresis device according to the present invention is therefore very effective for the two-dimensional separation of protein samples that produce spot intensities (concentrations) over a wide range.

### INDUSTRIAL APPLICABILITY

An electrophoresis device according to the present invention can overcome the disadvantages of electrophoresis apparatuses (two-dimensional electrophoresis apparatuses in particular) and advance the development of ongoing active proteome research. Further, since an electrophoresis device according to the present invention can be separately fabricated or marketed as a part or a component of an electrophoresis apparatus, it can boost the market in the field of machinery, chemistry, biology, or any other fields.

1-17. (canceled)

18. An electrophoresis device comprising an insulator,
wherein the insulator includes:
a first-separating-medium storing section for storing therein a first separating medium;
a first opening and a second opening that are in communication with the first-separating-medium storing section and for defining a direction of separation on the first separating medium; and
a light-transmissive portion for observing inside of the first-separating-medium storing section from outside, wherein the light-transmissive portion is covered with an anti-reflective layer.

19. The electrophoresis device as set forth in claim 18, wherein the first separating medium is stored in the first-separating-medium storing section.

20. An electrophoresis device comprising an insulator,
wherein the insulator includes:
a first-separating-medium storing section for storing therein a first separating medium;
a first opening and a second opening that are in communication with the first-separating-medium storing section and for defining a direction of separation on the first separating medium; and
a light-transmissive portion for observing inside of the first-separating-medium storing section from outside,
said electrophoresis device further comprising a light absorbing layer, provided opposite the light-transmissive portion with the first-separating-medium storing section in between.

21. The electrophoresis device as set forth in claim 20, wherein the first separating medium is stored in the first-separating-medium storing section.

22. The electrophoresis device as set forth in claim 20, comprising an anti-reflective layer,
wherein the light absorbing layer is provided opposite the anti-reflective layer with the first-separating-medium storing section in between.

23. The electrophoresis device as set forth in claim 18,
wherein the insulator includes a first plate-insulator and a second plate-insulator, and
wherein the first-separating-medium storing section is a depression formed in the first plate-insulator and covered with the second plate-insulator.

24. The electrophoresis device as set forth in claim 18,
wherein the insulator includes a first plate-insulator and a second plate-insulator,
wherein the first-separating-medium storing section is a depression formed in the first plate-insulator and covered with the second plate-insulator, and
wherein the anti-reflective layer is formed on the second plate-insulator.

25. The electrophoresis device as set forth in claim 18,
wherein the insulator includes a first plate-insulator and a second plate-insulator,
wherein the first-separating-medium storing section is a depression formed in the first plate-insulator and covered with the second plate-insulator, and
wherein the anti-reflective layer constitutes the second plate-insulator.

26. The electrophoresis device as set forth in claim 20,
wherein the insulator includes a first plate-insulator and a second plate-insulator,
wherein the first-separating-medium storing section is a depression formed in the first plate-insulator and covered with the second plate-insulator, and
wherein the light absorbing layer is formed on the first plate-insulator.

27. The electrophoresis device as set forth in claim 20,
wherein the insulator includes a first plate-insulator and a second plate-insulator,
wherein the first-separating-medium storing section is a depression formed in the first plate-insulator and covered with the second plate-insulator, and
wherein the light absorbing layer constitutes the first plate-insulator.

28. The electrophoresis device as set forth in claim 18, further comprising:
a first buffer chamber for reserving a first buffer to be brought into contact with the first separating medium at the first opening; and
a second buffer chamber for reserving a second buffer to be brought into contact with the first separating medium at the second opening.

29. The electrophoresis device as set forth in claim 28, wherein the insulator, the first buffer chamber, and the second buffer chamber are formed in one piece.

30. The electrophoresis device as set forth in claim 28, wherein the first buffer chamber and the second buffer chamber include a first electrode and a second electrode, respectively.

31. The electrophoresis device as set forth in claim 29, wherein the first buffer chamber and the second buffer chamber include a first electrode and a second electrode, respectively.

32. The electrophoresis device as set forth in claim 18, wherein the first opening or the second opening is shaped to fit a second separating medium retaining a sample.

33. An electrophoresis apparatus comprising:
an electrophoresis device of claim 18;
irradiating means for irradiating a sample in the first separating medium; and
detecting means for detecting fluorescence from the sample.

34. The electrophoresis apparatus as set forth in claim 33, further comprising first voltage applying means for applying voltage to the first separating medium.

35. The electrophoresis apparatus as set forth in claim 33, wherein a first electrode and a second electrode to be respectively inserted in a first buffer chamber and a second buffer chamber are provided on first wiring means connected to first voltage applying means.

36. The electrophoresis apparatus as set forth in claim 34, wherein a first electrode and a second electrode to be respectively inserted in a first buffer chamber and a second buffer chamber are provided on first wiring means connected to first voltage applying means.
